(19) United States
(12) Patent Application Publication
(10) Pub. No.: US 2009/0322473 A1
(43) Pub. Date: Dec. 31, 2009

(54) Remote controlled dead bolt door locking system

(76) Inventors: Peter Aliferis, Brampton (CA); Gabor Legeny, Brampton (CA)

Correspondence Address: PETER ALIFERIS, 15 BEECHWOOD CRESCENT, BRAMPTON, ON, L6T 1X9, CA

(21) Appl. No.: 12/453,381

(22) Filed: May 8, 2009

(30) Foreign Application Priority Data
May 14, 2008 (CA) 2,631,521

(51) Int. Cl. G05B 19/00; E05B 65/00; H02K 7/116; H02P 7/18

(52) U.S. Cl. 340/5.7; 70/91; 310/83; 318/139

(57) ABSTRACT

The remote controlled deadbolt door locking system (the “unit”) is designed to be an add-on safety mechanism for existing entry doors. The unit is designed to be mounted onto the bottom corner of a door, where in the engaged position, it prevents said door from being opened even if the main lock has been tampered with. The unit makes use of a small DC electric motor to move a steel shaft in the vertical direction into a steel bushing that is mounted into a drilled hole in the floor directly in front of the door and under the unit. The unit is mounted onto the door with four carriage bolts through the door, and a mounting plate from the outside of the door, through four matching holes in the unit itself. The unit is then simply tightened on with normal hex nuts. The unit is equipped with several safety circuits, which warn the user if any of the following occur: low battery or battery failure of either the main or backup batteries; the shaft does not fully engage upon closing; and if both batteries fall to a low condition. There is a built in triple redundancy to eliminate the possibility of the homeowner locking him/herself out. The operation of the unit is accomplished through a two-button remote control, or any commercially available remote entry system including but not limited to: fingerprint or voice recognition, or keypad entry. In this way, the unit acts just like a simple dead bolt, but one that can be locked while the homeowner is standing outside of the house.

This invention relates to a remotely operated electromechanical deadbolt mechanism used to secure a door. It is intended, but not limited to use for home residences.

The common deadbolt, especially when mounted onto the bottom of a door and engaged into a hole drilled in the floor (a foot-lock), is inaccessible from the outside, making it one of the simplest and safest methods for securing a door. The disadvantage of the deadbolt, however, is that it cannot be locked from outside of the house, unlike the common tumbler lock or a keypad lock. Whilst these locks offer the homeowner the ability to lock the door from the outside, they leave themselves open to tampering, and are also not as strong as the deadbolt when the door is subjected to an impact force.

Our solution to this problem is the amalgamation of the advantages of each of the aforementioned devices: the simple deadbolt and the simple lock. Our invention involves a simple motorized deadbolt unit, which, in response to a unique signal from a remote control, keypad entry or fingerprint or voice recognition device, will either extend the bolt—locking the door, or retract the bolt—unlocking the door. In this way, the door can now be locked and unlocked from either inside or outside the house.

The complete unit is shown in FIGS. 1 and 2. FIG. 1 shows the fully assembled unit as it would be mounted on a door: with mounting plate (13), carriage bolts (14), and cover (16). FIGS. 3, 4, and 5 show the unit mounted onto a door. The following is a list of the main components of the unit:

1. base plate

2. motor

3. reducing worm gear (driving gear)

4. gear mounting stud

5. shaft (bolt)

6. shaft securing plate

7. circuit

8. shaft mounted contactor

9. retract limit switch contact

10. extend limit switch contact

11. main battery

12. backup battery

13. mounting plate

14. carriage bolts

15. mounting nuts

16. cover

17. offset spacer

18. bushing
I Mounting the unit to the door is accomplished by using a provided template to mark the locations of the four through-holes at the bottom corner of the door. The four holes are drilled through the entire thickness of the door, and with cover (16) removed, the unit is then mounted to the inside of the door with four carriage bolts (14), mounting nuts (15), and mounting plate (13). An offset spacer (17) is placed between the door and the base plate (1). The template is again used to mark the precise location of the hole in the floor whilst the door is closed. This hole then receives a metal bushing (18), into which the bolt (5) will engage. The bushing is held down to the floor by a provided adhesive. (See FIGS. 3, 4, and 5)
II The overall function of the unit is to slide the shaft into the receiving bushing mounted in the floor. This is accomplished after the circuit-mounted receiver, receives the ‘lock’ signal from the transmitter, which is accomplished by pressing the appropriate button on the sending unit by the operator. (similar to a door lock/unlock keychain for automobile door locks).
III Once the circuit (7) receives said signal from the transmitter, it turns the motor (2) on. The motor shaft has an attached worm, which meshes with the appropriate reducing worm gear (3), which in turn, meshes with teeth cut into the side of the shaft (5). The shaft securing plate (6) has a slot through the side facing the gear (3), which allows said gear to operate the shaft (5). The shaft then extends linearly downward. A flat milled along one side of the shaft, perpendicular to the gear teeth, prevents the shaft from rotating. The shaft is held in place, and thus holds the door in place by the shaft securing plate (6).
IV The motor runs and hence the shaft extends in this way until the end of travel limit switch is triggered when the shaft mounted contactor (8) reaches the switch for the extended position (10). At this time, the motor turns off. The door is now secured with the engaging end of the shaft inside the floor bushing, and the other end held to the door by the shaft securing plate.
   There may arise a time when the shaft does not fully engage into the bushing. (e.g. the door is not closed properly). If this happens, the shaft will not extend all the way, and thus the shaft contactor does not make contact with the end of travel switch. If this contact does not occur within the nominal closing time, the circuit will sense this condition via an overtimer circuit and automatically reverse the motor and retract the shaft back to the fully retracted (unlocked) position (see part V for unlocking sequence) At the same time, an audible alarm will warn the operator that something is wrong. This alarm will sound for a set period of time.
V When the operator wishes to unlock the door (ie disengage the unit), he/she presses the unlock button on the remote controller, and the motor runs in reverse and retracts the shaft until the shaft mounted contactor (8), reaches the end of travel limit switch for the retracted position (9), at which point the circuit turns the motor off. We are now back at section II.

### Additional Specifications

The power to the unit is provided by a standard battery. A secondary battery of the same type provides power if the main battery falls to a low level, or in the unlikely event that the main battery fails. When either of these two conditions is reached, the circuit automatically switches to the backup battery and an LED turns on to show that the battery needs to be replaced. This light will remain on until said battery is replaced. In the event that both batteries fall to a low level, both LED's will be lit, and also an audible alarm will sound until at least one of the batteries is replaced. In addition, the unit will retract the bolt to the unlocked position and prevent any future operations until the batteries are replaced. This prevents the unwanted condition of the unit getting stuck in the locked position when the operator is outside of the house.

### Other Mounting Possibilities

Owing to the unit's straightforward method of mounting, it is possible to mount the unit sideways on the door, so that the bolt engages horizontally into a clasp mounted to the door frame, instead of into a floor mounted bushing. Although this configuration is intrinsically weaker than the proposed floor mounted one, it may be more desirable for those who do not wish to drill their floor.

### DESCRIPTION OF DRAWINGS

FIG. 1 shows a perspective drawing of the unit, as it would appear fully assembled, with mounting plate and bolts attached. The door is not shown in this figure.

FIG. 2 shows the same perspective view of the unit as FIG. 1; however in this figure, the cover has been removed for clarity, offering a view of the inside components.

FIG. 3 shows a perspective view of the unit from the inside of the house, as it would be mounted on a door, when used along with the floor bushing. The bushing is shown in this view, with the securing shaft extended into said bushing. The floor is absent from this view for clarity.

FIG. 4 is simply a close-up, cropped view of the unit as it appears in FIG. 3.

FIG. 5 is a cross-sectional view of the unit with mounting hardware and offset spacer, the bushing, the door, and the floor. It shows the unit mounted on the bottom of a door, with the securing shaft extended into the floor bushing.

FIG. 6 is a bottom view of the unit, with cover removed for clarity.

FIG. 7 is a top view of the unit, with cover removed for clarity.

FIG. 8 is a side view of the unit, with cover removed for clarity.

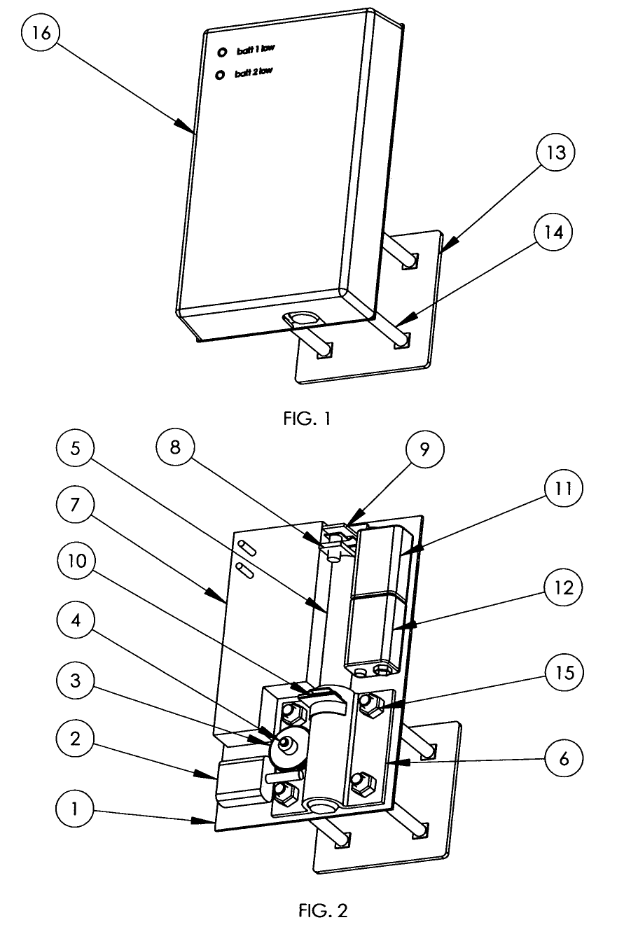

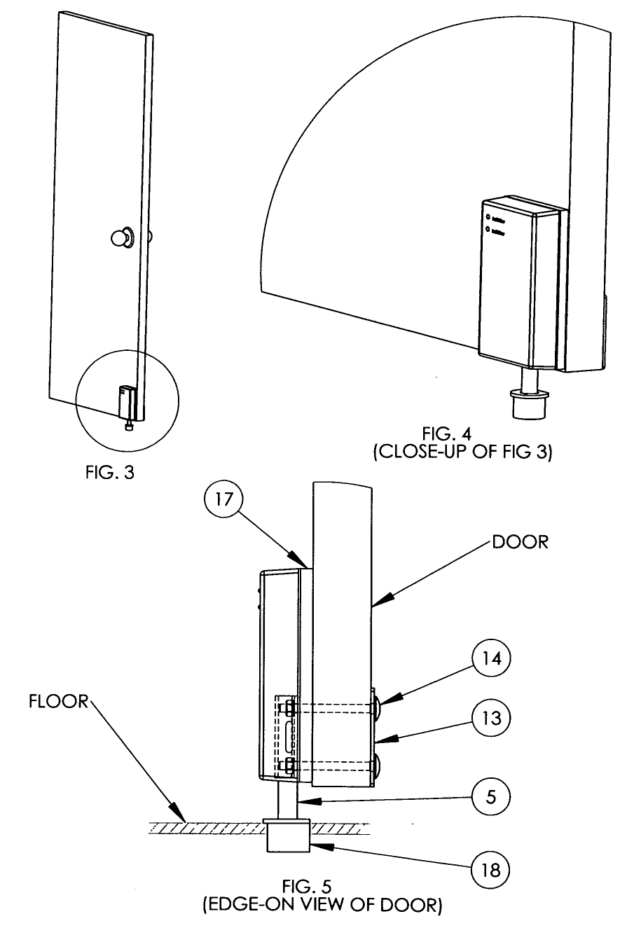

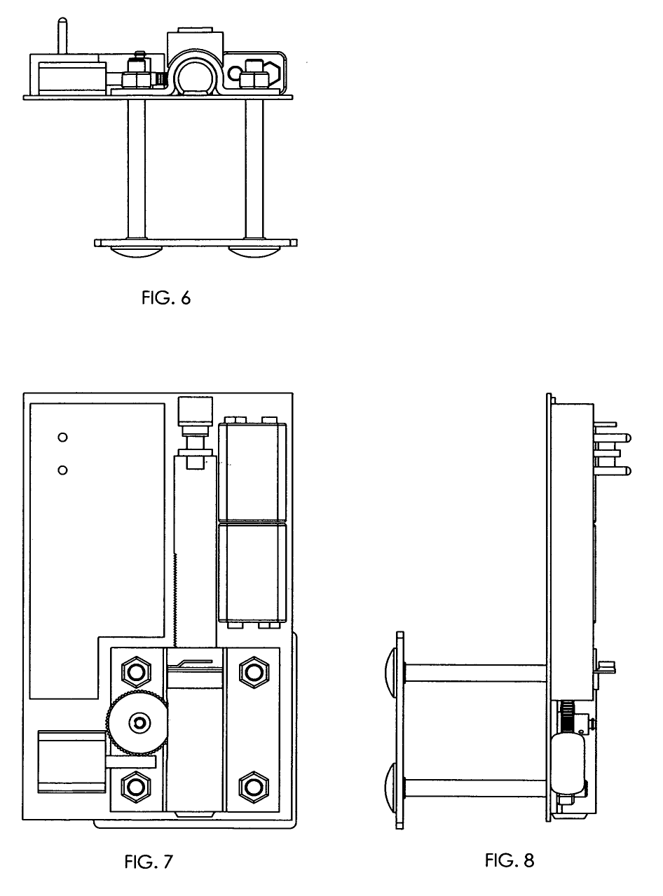

All figures were drawn to facilitate explanation of the workings and components of the invention. Where the word “unit” is used, it means the remote controlled deadbolt locking mechanism, which is the subject of this patent application.

1. A battery powered remote controlled deadbolt door locking system that is mounted on the inside of a door, and in which a shaft/bolt engages a bushing which is mounted into a hole drilled into the floor, or a clasp mounted to the door frame.

2. An electromechanical device as defined in claim 1, comprising:
a DC electric motor engaging a steel shaft, which extends into or retracts out of the bushing defined in claim 1;
a steel support stamping which securely holds and guides said shaft, and through which the door is securely held closed;
two electrical contact switches for determining the end of travel condition of said shaft;
a contact mounted to said shaft, which contacts said switches;
a worm gear which reduces the speed of said DC motor and which engages meshing teeth on one side of said shaft through a slot in the side of said steel support stamping;
a printed circuit board (PCB), to control said motor based on user input through a two button remote control;
a dual battery system to supply power to said PCB, whose function is to switch from the main battery to the secondary battery in the event that the main battery falls to a low power level;
a warning system with audible alarm and two visible LED's, contolled by said PCB to warn user of low battery conditions and shaft engagement problems;
an overtimer circuit, whose function is to disable the motor and retract the bolt if the extend limit switch is not reached in a set period of time;
a failsafe system to retract the bolt, and prevent future operation of the unit if both batteries fall to a low level. Said system function is carried out by the PCB;
a cover having two holes through which said warning LED's can be seen, and also having one cutout to allow said shaft to pass through;
a base plate to which the aforementioned components are assembled;
a mounting plate through which 4 carriage bolts hold the entire unit onto door;
a spacer which mounts between the unit and the door, whose function is to allow the shaft and bushing centerline to be placed at the correct distance from the bottom of the door frame.

3. A device as defined in claims 1 and 2, which locks an interiorly mounted deadbolt from inside or outside of a house using a coded radio frequency receiver, and which is inaccessible to potential tampering from the outside, in any way except through the use of power tools.

4. A device as defined in claims 1, 2, and 3, which can also be set up to operate from the outside of a house using a fingerprint or voice recognition system or keypad entry system.
